(19) United States
(12) Patent Application Publication
(10) Pub. No.: US 2011/0127327 A1
(43) Pub. Date: Jun. 2, 2011

(54) MECHANISM FOR INVENTORY CONTROL AND/OR THEFT DETERRENCE OF AN ABSORBENT PAD

(75) Inventor: RONALD JENSEN, Chicago, IL (US)

(73) Assignee: PAPER-PAK INDUSTRIES

(21) Appl. No.: 12/959,127

(22) Filed: Dec. 2, 2010

Related U.S. Application Data
(60) Provisional application No. 61/266,097, filed on Dec. 2, 2009.

(51) Int. Cl. G06Q 90/00; G06K 19/02; G06K 19/077; G06K 19/06

(52) U.S. Cl. 235/385; 235/488; 235/492; 235/493; 235/487; 235/375

(57) ABSTRACT

The present disclosure is directed to an absorbent pad having a mechanism for theft detection and deterrence, and/or inventory control, including product tracking. The mechanism is positioned at an edge of the pad, thereby maintaining effectiveness, even when the pad is covered by a food product or exposed to a dielectric effect created by food liquids or salts in the package.

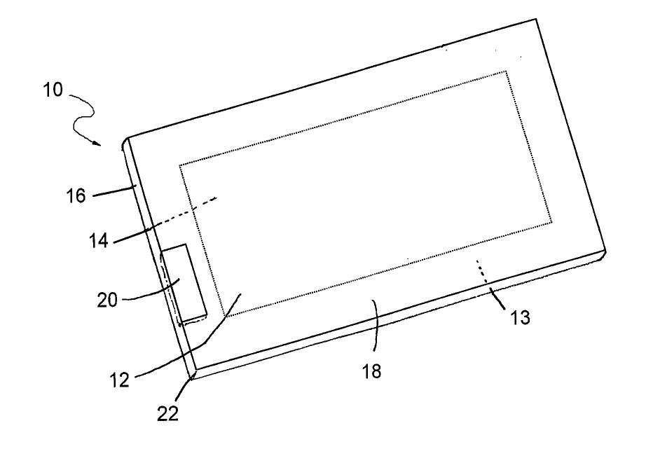

### CROSS-REFERENCE TO RELATED APPLICATIONS

The present application claims the benefit of U.S. Provisional Application No. 61/266,097, filed on Dec. 2, 2009, the contents of which are hereby incorporated by reference.

### BACKGROUND OF THE DISCLOSURE

1. Field of the Disclosure

The present disclosure is directed to an absorbent pad having a mechanism for inventory control, including product tracking, and/or theft detection in which the mechanism is positioned at or near an edge of the pad to maintain effectiveness, even when the pad is covered or contacted by a food product, or liquids or salts in the food package.

2. Description of the Related Art

Absorbent pads are used in the retail packaging industry to absorb excess moisture and fluids exuded from meat, poultry, seafood, produce, flowers, and other perishables, to provide a safer, more appealing product to place on the retail store shelf for sale to the public.

Absorbent pads may contain emitter-detector devices as part of an Electronic Article Surveillance (EAS) system, for theft detection and deterrence. Common EAS devices include Radio Frequency (RF) tags (such as Radio Frequency Identification (RFID) tags), Acousto-Magnetic (AM) tags, and Electromagnetic (EM) tags. The tag is placed in an absorbent pad, and triggers an alarm when passed through detection pedestals at the store exit unless deactivated or removed at the checkout counter. Such devices are typically “single-bit” devices because the tag is either on or off. As an example, an RFID tag can be placed inside an absorbent food pad and concealed from view, and interacts with a remote detector to activate an alarm.

Absorbent food pads having EAS devices are increasingly used for theft deterrence, particularly for food packages containing expensive foods.

However, a drawback of a conventional absorbent pad having an EAS tag in a food package is that a portion of the food product can cover the EAS tag and interfere with activation by the remote sensor or detector, thereby preventing proper operation of the system.

Another drawback is that liquids exuded from the food, as well as liquids, preservatives, marinades, salts or seasonings that are inside the food package, can produce a dielectric effect that interacts with the tag and interferes with proper operation of the detection system.

### SUMMARY OF THE DISCLOSURE

The present disclosure provides an absorbent pad having a mechanism that is positioned at or near an outer edge of the absorbent pad, for inventory control, including product tracking and/or theft detection or deterrence.

The mechanism can be an emitter or an acceptor device. Significantly, the mechanism is positioned at or near an outer edge and/or corner of an absorbent pad. It has been determined that this placement of the mechanism maintains the effectiveness of the mechanism even when the mechanism is partly or completely covered by a food product, or exposed to a dielectric effect created by food, including food liquids and juices, preservatives, marinades, salts and/or seasonings that are in the package. The mechanism is activated when brought in proximity of a remote detection system.

The absorbent pad containing the mechanism, such as a tag, can be used for theft detection and theft deterrence, product tracking, and/or inventory control.

### BRIEF DESCRIPTION OF THE DRAWING

The drawing is a perspective view of an exemplary embodiment of an absorbent pad and a mechanism of the present disclosure.

### DETAILED DESCRIPTION OF THE DISCLOSURE

Referring now to the drawing, an absorbent pad generally represented by reference numeral 10 is shown, having a mechanism 20 of the present disclosure. Mechanism 20 can be used for theft detection and theft deterrence, and/or inventory control, including product tracking.

Absorbent pad 10 has at least one layer. In an exemplary embodiment, absorbent pad 10 has a top layer 12 and a bottom layer 14, with an absorbent body 13 therebetween. Absorbent body 13 is made of one or more layers of an absorbent material.

In an exemplary embodiment, absorbent pad 10 has an outer edge 16. Outer edge 16 is preferably entirely around the periphery of absorbent pad 10. Along edge 16 of absorbent pad 10 and inward for a certain distance, shown in the drawing as a dotted line, is an area 18 (also called a track or zone) in which mechanism 20 is preferably positioned. In an exemplary embodiment, mechanism 20 is positioned in absorbent pad 10 in an area of the pad on which the food product is not placed. In still another exemplary embodiment, mechanism 20 is placed near, but not on, outer edge 16 of absorbent pad 10.

When used in a food package, “near” means anywhere within the food package, but not on absorbent pad 10 or on the food product. When the absorbent pad 10 is not in a food package, “near” means a distance from an edge of the pad that is about 10% or less of the total width of absorbent pad 10. For example, where absorbent pad 10 has a total width of 3 inches (76 mm), mechanism 20 is placed within 0.3 inches (7.6 mm) (i.e., 10% of the total width) of the pad edge, regardless of whether the edge borders the width or length of absorbent pad 10.

In those embodiments where the width of mechanism 20 is greater than the 10% zone width, as long as at least an edge or portion of mechanism 20 that borders the pad edge is in the 10% zone, mechanism 20 is considered to be within the 10% zone.

Mechanism 20 can be a tag that is an emitter or an acceptor device. Mechanism 20 is activated when brought in proximity to a detector (not shown) so that the mechanism and detector form a detection system. In an exemplary embodiment, mechanism 20 is an RFID tag that is positioned in area 18 of absorbent pad 10. In an exemplary embodiment, the RFID tag operates over operating ranges of about 400 MHz to about 1000 MHz. The RFID tag is positioned near or at outer edge 16 and, preferably, near a corner 22 of absorbent pad 10. In another exemplary embodiment, a portion of mechanism or tag 20 must contact, or nearly contact, outer edge 16 and corner 22 of absorbent pad 10.

Examples of mechanism 20 include, but are not limited to, an inventory control device and a theft detection device.

The position in the architecture of absorbent pad 10 is important to maintain the effectiveness of mechanism 20. When a food product (not shown) placed on absorbent pad 10 partly or completely covers mechanism 20, the detection by mechanism 20 is not compromised, unlike other devices. When mechanism 20 is exposed to a dielectric effect that is created by the food, its liquids and/or juices, or preservatives, marinades, salts and/or seasonings present inside the food package as free liquid, the emission or detection by mechanism 20 is not compromised, again, unlike other devices. A dielectric effect can be created by any food product placed on an absorbent pad, but especially by packaged meat (such as beef, pork, lamb, seafood, and poultry), fruit, vegetable, and non-edible products (such as flowers).

Positioning mechanism 20 at or near outer edge 16 of absorbent pad 10, rather than near the center, makes a difference in that the electronic information communicated by the mechanism can be read by a minimum of about 0.5 meters and up to about 8 meters or more, depending on the electrical or radio environment that exists at the time of reading. Thus, the placement of mechanism 20 at or near an edge of pad 10, but at a position that does not have the food product enhances exponentially the distance from which mechanism 20 can be read.

The placement of mechanism or tag 20 at or near an outer edge of absorbent pad 10 also improves the radio efficacy of EAS tags used in the pad under meats or other foods.

Furthermore, consistent placement of mechanism 20 in area 18 of pad 10 provides a consistently effective means for mechanism 20 to be activated, even when covered by a food product or exposed to a dielectric effect from food liquids that would otherwise impair effectiveness.

Mechanism 20 can also communicate information identifying a product in a package to track inventory, providing information about product sales, and re-stocking products on shelves. In addition, the information can be used to speed product checkout by providing a way to identify a package in a cart to be purchased without removal of the package from the cart.

Mechanism 20 can have encoded or encrypted information that can be read by the detector (not shown) about the packaged product. The information can be used for inventory control, including product tracking. This information enables the retail store to track product movement, as well as determine re-stocking and re-ordering needs.

Mechanism 20 can be secured on or in absorbent pad 10 by an adhesive layer on one or more surface of the mechanism. Mechanism 20 can be positioned and secured to absorbent pad 10 by an applicator unit. The force of the applicator unit also causes mechanism 20 to push slightly into a tissue layer of absorbent pad 10, which is a carrying tissue layer, to help secure the mechanism in place after it is applied to pad by the application unit. Additional tissue layers disposed on mechanism 20, as well as the overall core structure of the absorbent pad, also help anchor the mechanism and prevent migration.

Placement of mechanism 20 in absorbent pad 10 during manufacture provides a more convenient product for retail use. It eliminates the need for the retailer to insert a tag (or other mechanism) for inventory control and/or theft deterrence.

Thus, absorbent pad 10 of the present disclosure has at least two functions, namely, absorb excess liquids in a food package, and detect theft of the product and/or track product inventory. This latter is enhanced by the placement of mechanism 20. By placing mechanism 20 near the outer edges including corners of a rectangular shaped absorbent pad, it greatly enhances the radio efficacy of the mechanism, negating the dielectric effect of food, its liquid and/or juices, and other constituents, including salts and marinades. This is especially true of meats (e.g., beef, pork, Iamb, poultry, and seafood) but it can apply to any food or product that operates as a dielectric (e.g., fruits, vegetables, flowers, etc.). This is true for operating ranges from 400 MHz to 1000 MHz. This placement, versus the center or near-center of the pad, makes the difference of reading electronic information on the mechanism by a minimum of 0.5 meters up to 8 meters or more, depending upon the electrical or radio environment that exists at the time of the reading. The outer placement also improves the radio efficacy of EAS tags in pads placed under meats and other foods.

The word “about,” as used herein for dimensions, weights, weight-percentages, or measures of absorbency, means a range that is ±10% of the stated value, more preferably ±5% of the stated value, and most preferably ±1% of the stated value, including all subranges therebetween.

The disclosure and embodiments described herein are exemplary, and should not be construed as implying any particular limitation on the scope of the claims. Various alternatives, combinations and modifications could be devised by those skilled in the art without departing from the present disclosure. The present disclosure embraces all such alternatives, modifications and variances that fall within the scope of the claims and the subject matter disclosed herein.

What is claimed is:

1. An absorbent pad for inventory control of a product disposed thereon comprising:
an absorbent pad having a layer with an outer edge around the periphery of said absorbent pad; and
an inventory control device disposed along said outer edge, wherein said inventory control device is activated in proximity to a detector to communicate inventory control information about the product.

2. The absorbent pad according to claim 1, wherein said absorbent pad further comprises:
a top layer;
a bottom layer opposite said top layer; and
an absorbent body disposed between said top layer and said bottom layer, said absorbent body having one or more layers of an absorbent material.

3. The absorbent pad according to claim 1, wherein said inventory control device is disposed in a zone along said outer edge that is no greater than 10% of the total width of said absorbent pad.

4. The absorbent pad according to claim 1, wherein said inventory control device is positioned near a corner of said absorbent pad.

5. The absorbent pad according to claim 1, wherein said inventory control device is disposed on an outer surface of said absorbent pad.

6. The absorbent pad according to claim 2, wherein said inventory control device is disposed between said top layer and said bottom layer of said absorbent pad.

7. The absorbent pad according to claim 1, wherein said inventory control device is selected from the group consisting of: Radio Frequency Identification (RFID) tag, Acousto-Magnetic (AM) tag, Electromagnetic (EM) tag, Electronic Article Surveillance (EAS) tag, and any combinations thereof.

8. The absorbent pad according to claim 1, wherein said inventory control device operates over an operating range of about 400 MHz to about 1000 MHz.

9. The absorbent pad according to claim 1, wherein said inventory control device has an effective communication range that is not compromised when partly or completely covered by the product disposed on said absorbent pad.

10. The absorbent pad according to claim 1, wherein said inventory control device has an effective communication range that is not compromised when exposed to a dielectric effect created by the product disposed on said absorbent pad.

11. The absorbent pad according to claim 2, wherein said inventory control device further comprises an adhesive layer disposed on said top layer or said bottom layer, wherein said adhesive layer secures said inventory control device to said absorbent pad.

12. The absorbent pad according to claim 2, wherein the product disposed on said absorbent pad is a food product that exudes juices, and wherein said exuded juices are absorbed by said one or more layers of absorbent material.

13. The absorbent pad according to claim 2, wherein the product disposed on said absorbent pad is a flower that is packaged with excess water, and wherein said water is absorbed by said one or more layers of absorbent material.

14. An absorbent pad for theft detection of a product disposed thereon comprising:
an absorbent pad having a layer with an outer edge around the periphery of said absorbent pad; and
a theft detection device disposed along said outer edge, wherein said theft detection device is activated in proximity to a detector to communicate theft detection information about the product.

15. The absorbent pad according to claim 14, wherein said absorbent pad further comprises:
a top layer;
a bottom layer opposite said top layer; and
an absorbent body disposed between said top layer and said bottom layer, said absorbent body having one or more layers of an absorbent material.

16. The absorbent pad according to claim 14, wherein said theft detection device is disposed in a zone along said outer edge that is no greater than 10% of the total width of said absorbent pad.

17. The absorbent pad according to claim 14, wherein said theft detection device is positioned near a corner of said absorbent pad.

18. The absorbent pad according to claim 14, wherein said theft detection device is disposed on an outer surface of said absorbent pad.

19. The absorbent pad according to claim 15, wherein said theft detection device is disposed between said top layer and said bottom layer of said absorbent pad.

20. The absorbent pad according to claim 14, wherein said theft detection device is selected from the group consisting of: Radio Frequency Identification (RFID) tag, Acousto-Magnetic (AM) tag, Electromagnetic (EM) tag, Electronic Article Surveillance (EAS) tag, and any combinations thereof.

21. The absorbent pad according to claim 14, wherein said theft detection device operates over an operating range of about 400 MHz to about 1000 MHz.

22. The absorbent pad according to claim 14, wherein said theft detection device has an effective communication range that is not compromised when partly or completely covered by the product disposed on said absorbent pad.

23. The absorbent pad according to claim 14, wherein said theft detection device has an effective communication range that is not compromised when exposed to a dielectric effect created by the product disposed on said absorbent pad.

24. The absorbent pad according to claim 15, wherein said theft detection device further comprises an adhesive layer disposed on said top layer or said bottom layer, wherein said adhesive layer secures said theft detection device to said absorbent pad.

25. A method for inventory control of a product comprising:
placing the product on an absorbent pad, said absorbent pad comprising:
a layer with an outer edge around the periphery of said absorbent pad, and
an inventory control device disposed along said outer edge,
positioning a detector that activates said inventory control device in proximity to said detector to communicate inventory control information about the product.

26. A method for theft detection of a product comprising:
placing the product on an absorbent pad, said absorbent pad comprising:
a layer with an outer edge around the periphery of said absorbent pad, and
a theft detection device disposed along said outer edge,
positioning a detector that activates said theft detection device in proximity to said detector to communicate theft detection information about the product.
